(19) United States
(12) Patent Application Publication
(10) Pub. No.: US 2008/0059328 A1
(43) Pub. Date: Mar. 6, 2008

(54) SYSTEM AND METHOD FOR PAYMENTS THROUGH AN ON-LINE MESSAGE BOARD OR FORUM

(76) Inventor: ERIC MCCARTY, Johnson City, TN (US)

Correspondence Address: W. EDWARD RAMAGE, COMMERCE CENTER SUITE 1000, 211 COMMERCE ST, NASHVILLE, TN, 37201, US

(21) Appl. No.: 11/846,978

(22) Filed: Aug. 29, 2007

Related U.S. Application Data
(60) Provisional application No. 60/823,813, filed on Aug. 29, 2006.

(51) Int. Cl. G06Q 30/00

(52) U.S. Cl. 705/26

(57) ABSTRACT

A system and method for providing payments to a poster on a message board or forum. The poster can be the poster originating a thread, or a poster posting a response in a thread. Compensation means are associated with the post, and activation of said compensation means initiates a payment process leading to the payment of compensation to the poster. The compensation means may comprise a button or icon in or near the post. The payment process may include a payment screen activated by activating of the compensation means, said payment screen prompting the activator of the compensation means to designate a payment amount. The payment amount is transferred from one or more accounts of the person activating the compensation means, to an account or accounts of the poster. Payment may be through accounts maintained by the message board or forum site, or through a third party site, such as Paypal. A portion of each payment amount may be received by the message board or forum.

This application claims the benefit of U.S. Provisional Application No. 60/823,813, entitled “SYSTEM AND METHOD FOR PAYMENTS THROUGH AN ON-LINE MESSAGE BOARD OR FORUM,” filed Aug. 29, 2006 by Eric McCarty, and is entitled to the benefit of that filing date for priority. The entire specification, drawings, appendices and attachments of U.S. Provisional Application No. 60/823,813 are incorporated herein by specific reference.

### FIELD OF INVENTION

This invention relates to online message boards and forums. More particularly, the present invention relates to a system and method for a poster on a message board or forum to receive payments from readers based on the reader's estimation of the value of the poster's messages or postings.

### BACKGROUND OF THE INVENTION

Online message boards and forums are well-known and widely-used today. A wide variety of boards have appeared at a variety of Internet web sites originating throughout the world, covering a variety of topics. Some sites have a single board, while some sites have multiple boards, organized in a variety of fashions. Some are open to all corners, while others require posters (and sometimes readers) to be registered.

The quality of posts on the boards also varies greatly. The majority of posts contain little information of use, while occasional posts do contain information of substance to at least a portion of the readers. However, such posts often get lost in the deluge of posts seen at many sites. In addition, there is little tangible incentive for a poster to author such posts.

Accordingly, what is needed is a system and method whereby a poster is encouraged to author posts containing useful or substantial information for readers, and can receive a tangible reward for such posts.

### SUMMARY OF THE INVENTION

The present invention comprises a system and method for providing payments to a poster on a message board or forum. The poster can be the poster originating a thread, or a poster posting a response in a thread. A poster originating a thread can indicate that he or she is willing to provide a tip, reward or compensation to a response. Such a thread may be distinguished in the listing of threads at the message board or forum.

Compensation means are associated with the post, and activation of said compensation means initiates a payment process leading to the payment of compensation to the poster. The compensation means may comprise a button or icon in or near the post. The compensation means may be labeled with an appropriate symbol, word, or combination thereof, and may be colored or otherwise configured so as to draw the attention of readers of the post.

The payment process may include a payment screen activated by activating of the compensation means, said payment screen prompting the activator of the compensation means to designate a payment amount. The payment amount is transferred from one or more accounts of the person activating the compensation means, to an account or accounts of the poster. Payment may be through accounts maintained by the message board or forum site, or through a third party site, such as Paypal. A portion of each payment amount may be received by the message board or forum.

### DESCRIPTION OF THE DRAWINGS

FIG. 1 shows a view of one exemplary embodiment of the present invention.

FIG. 2 shows a view of another exemplary embodiment of the present invention.

FIG. 3 shows a view of a new thread creation screen in accordance with one exemplary embodiment of the present invention.

FIG. 4 shows a view of a thread listing in accordance with one exemplary embodiment of the present invention.

FIG. 5 shows a view of a payment screen in accordance with one exemplary embodiment of the present invention.

FIG. 6 shows a third-party site log-in screen in accordance with one exemplary embodiment of the present invention.

FIG. 7 shows a diagram of payment processing using in-house accounts in accordance with one exemplary embodiment of the present invention.

FIG. 8 shows a diagram of payment processing using third-party accounts in accordance with one exemplary embodiment of the present invention.

FIG. 9 shows a diagram of payment processing using Paypal accounts in accordance with one exemplary embodiment of the present invention.

FIG. 10 shows a diagram of payment processing using one existing Paypal account in accordance with one exemplary embodiment of the present invention.

FIG. 11 shows another diagram of payment processing using one existing Paypal account in accordance with one exemplary embodiment of the present invention.

FIG. 12 shows a registration screen in accordance with one exemplary embodiment of the present invention.

### DETAILED DESCRIPTION OF THE INVENTION

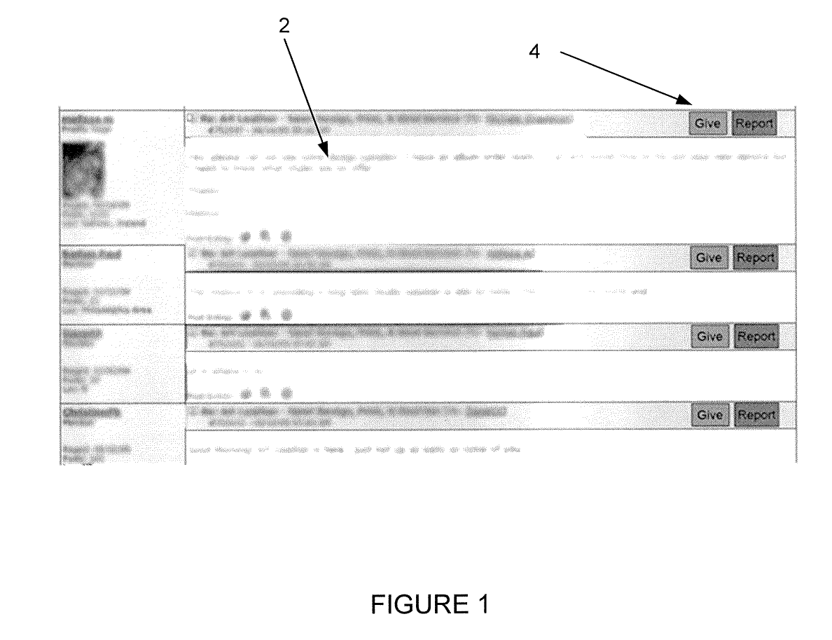

Referring now to the numerous figures, wherein like references identify like elements of the invention, FIG. 1 illustrates an exemplary embodiment of the invention comprising a post 2 on a message board or forum with means 4 for a reader to reward the poster of the post 2. FIG. 1 shows said reward means 4 as a button on the post 2 that the reader can click on or otherwise activate. As shown in FIG. 1, the button 4 may be marked with “GIVE,” or some other word indicating its purpose.

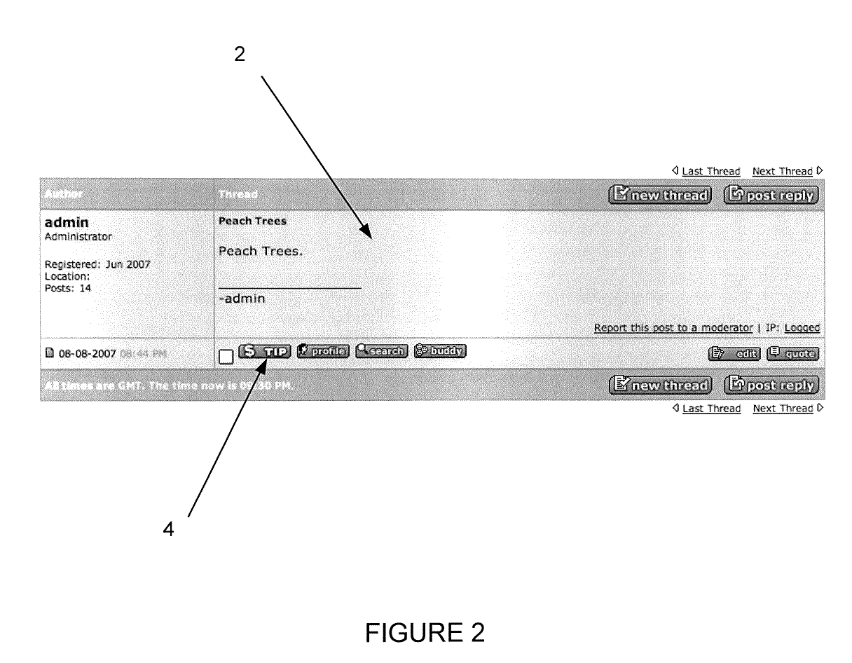

FIG. 2 shows another exemplary embodiment of the present invention, with reward means 4 comprising a “$ TIP” button at the bottom of the post. Other words or symbols (including symbols for other forms of currency, as appropriate for the particular forum) may be used on the reward means or button 4, and the button may be colored to draw attention to its presence (the color used depends on the color scheme for the forum, such as, as a nonlimiting example, a green button on a neutral or grey or light blue background). The location of the reward means 4 also may vary, and is not limited to the locations shown in the exemplary figures.

In one exemplary embodiment of the invention, the originating poster may be the individual seeking a reward, tip or compensation from readers of the post. The initial reward means 4 is associated with the original post. Readers of the post can activate the reward means 4 to reward the poster for any reason, including the substance of the post, information contained in the post, entertainment value, or other reasons. Readers need not post a reply in the thread (a thread generally comprising an original post and all subsequent responsive posts, including responses to responses). Replies may be posted in the thread, and readers may activate separate reward means 4 for the responses in the thread, so that some or all posts in a thread may be rewarded.

In another exemplary embodiment, the originating poster may be seeking information, or a response to an inquiry or question, and be willing to reward, tip or compensate a person who provides an answer or the sought-after information. The reward means 4 is associated with the subsequent, response post (or posts). The originating poster then may activate the reward means 4 for responses that he or she deems worthy of reward or compensation. Other readers of the posts in the thread also may activate the reward means 4 for responses they deem worthy (and may even activate the reward means 4 for the originating poster, if desired).

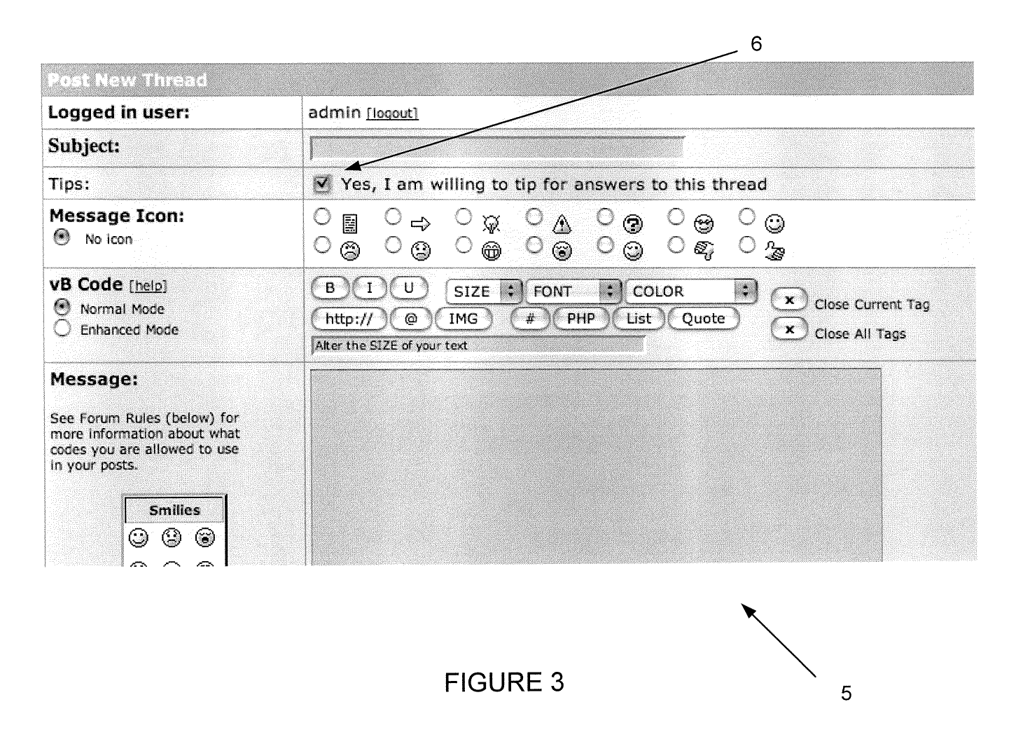

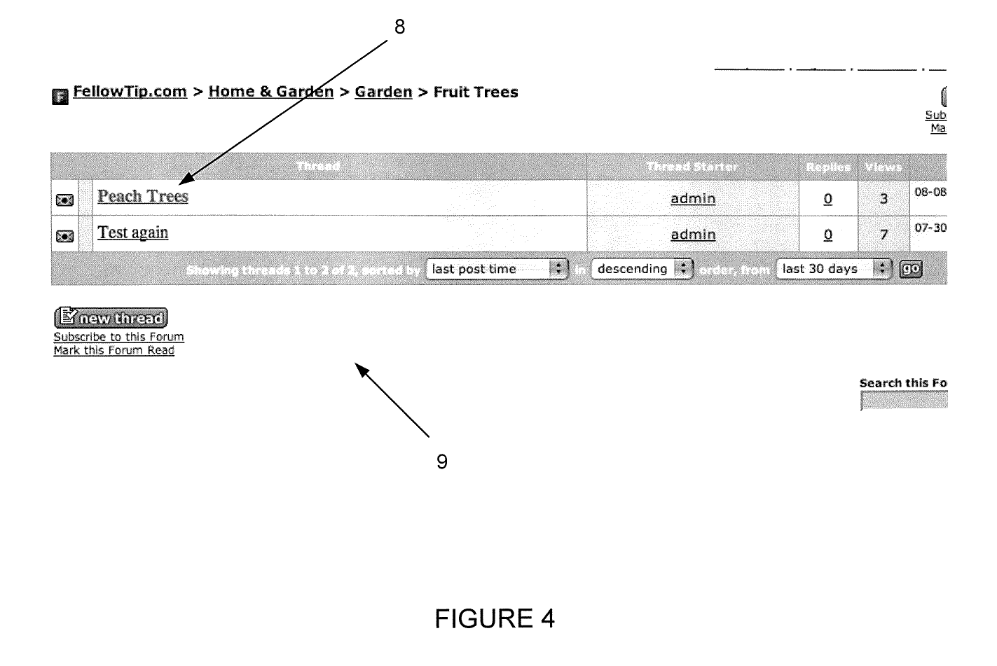

FIG. 3 shows an embodiment of a new thread creation screen 5, where the originating poster creating the first, or original, post in the thread can indicate that he or she is willing to tip for answers or responses to the thread, in the case where the originating poster is seeking information or a response to an inquiry or question. The indicating means 6 may be a check box (as shown in FIG. 3), a button, an input field, or some similar means. As shown in FIG. 4, the newly created thread 8 may then be indicated in a thread listing 9 as one where the originating poster is willing to tip or reward for answers or responses. This indication varies depending on the color scheme and configuration of the forum or board in which the thread is created, including, but not limited to, a different color from other threads (e.g., green), highlighting, bolding, underlining, or the addition of a symbol or word or combination thereof (e.g., a version of the “$ TIP” button next to the thread title in the listing).

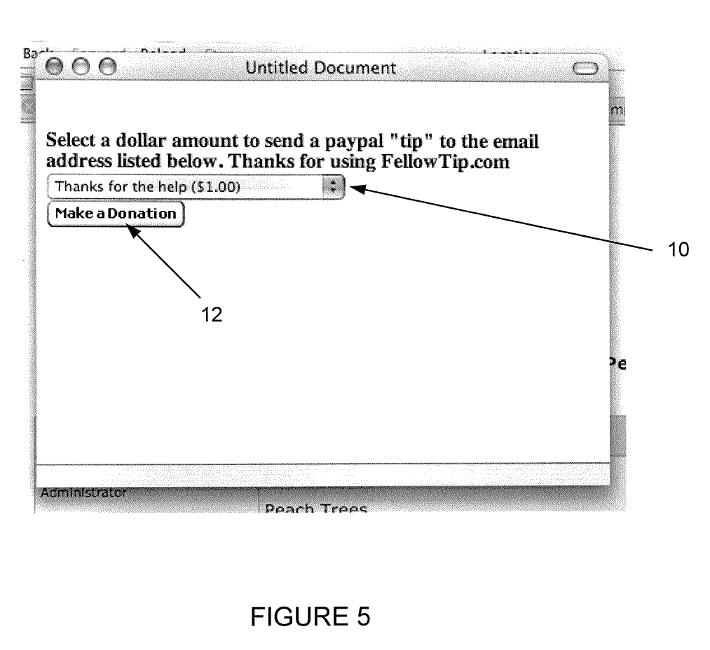

In one exemplary embodiment, upon activating the reward means 4, the grantor of the reward (as noted above, the grantor may be the originating poster or a reader of a post) is prompted to enter a payment amount to be sent to the poster being rewarded from the grantor. This prompt may be superimposed on the post, opened in a new window, or be shown on a new screen in the window that the thread was in. The payment amount may be any amount the grantor deems appropriate, based upon the value of the post 2 to the reader. This value may be objective or subjective, and can include material or entertainment value. A shown in FIG. 5, a tip or reward amount 10 may be initially suggested (the initial or default value of the tip amount may vary, depending on the forum in which the thread appears, and may, in some embodiments, be set by the administrators of the forum or the originating poster). Entering the amount and clicking a button or other icon 12 to proceed (which can be done with or without confirmation) would then cause the transfer to be made or would direct the reader to a third-party transfer or account site, such as Paypal.com, as described above. The prompt may or may not be in a secure window.

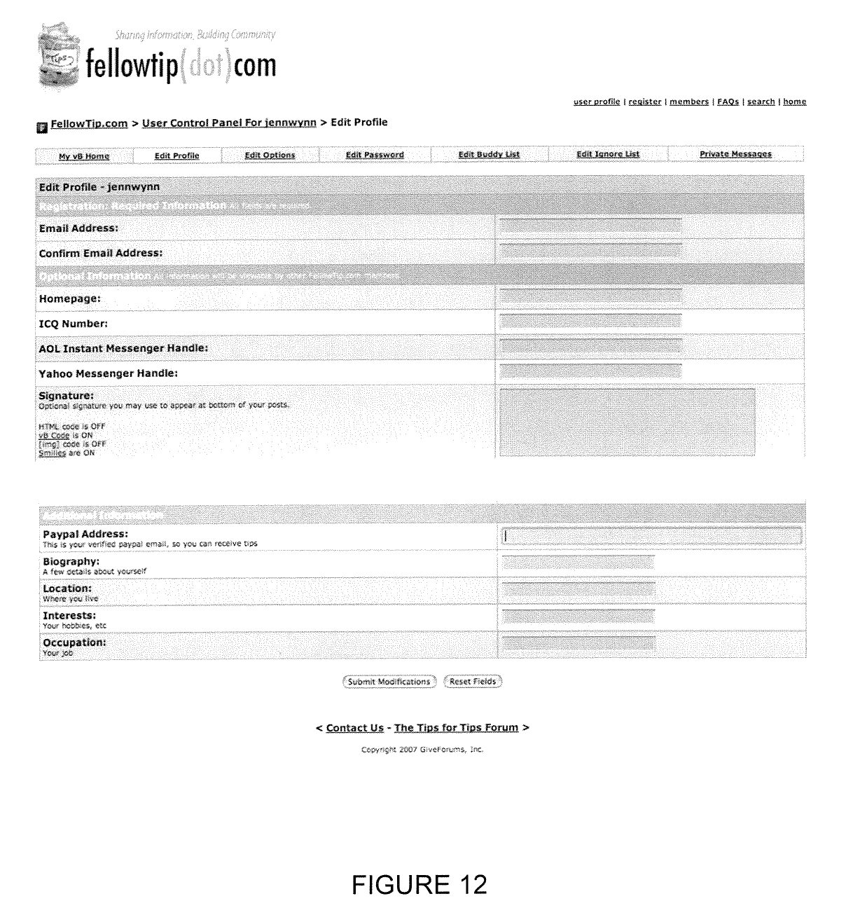

The payment may be made to an account of the poster from an account of the grantor. One or both of these accounts may be maintained by an owner, operator or person or entity affiliated with the message board containing the post 2. The poster or grantor, or both, may be required to register in order to post on the message board, or cause payments to be made. The registration information may include username, password, contact information, and information about an account to which payment may be made to or from, such as a Paypal.com account (as shown in FIG. 12).

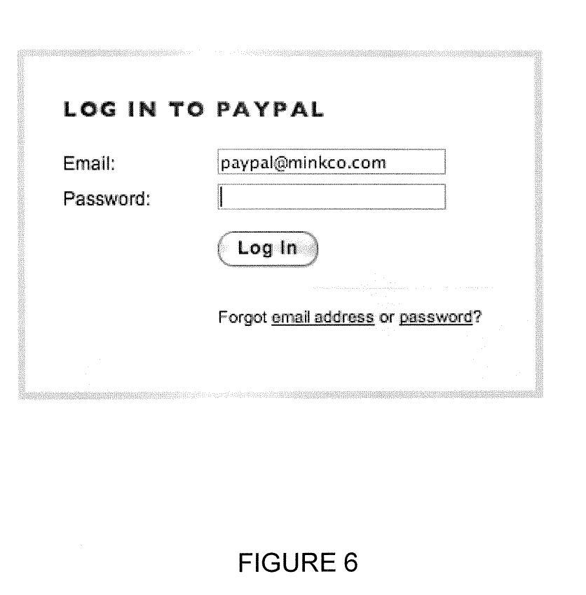

In another exemplary embodiment, activating the reward means 4 may direct the grantor to a third-party financial transfer or account site, such as Paypal.com, to complete the transfer. If a Paypal or third party account is used, then the grantor may be directed to log into that account, as shown in FIG. 6. Some form of identification of the account of the poster being reward may be transferred as part of this process to the third-party site, so that the third-party site knows to whom to direct payment.

In an alternative embodiment, activating the reward means 4 would cause the grantor to proceed directly to a third-party site, such as Paypal. The transaction, including the designation of the tip or reward amount, can then be completed there.

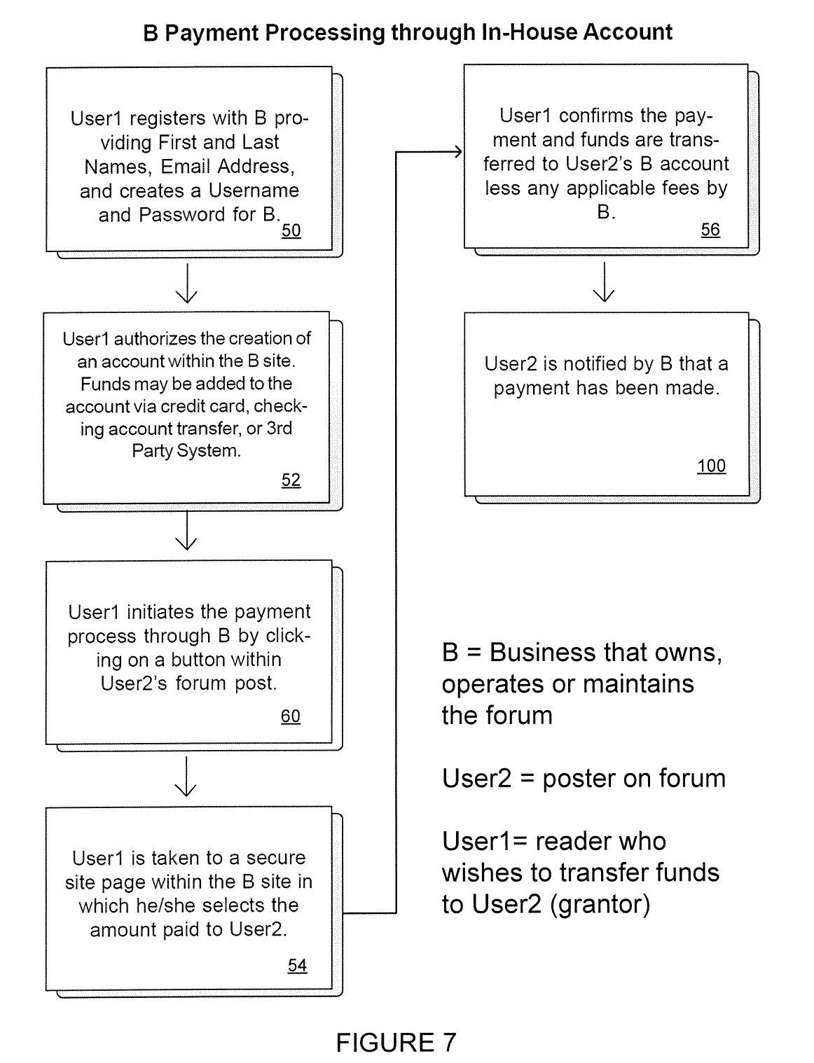

FIGS. 7 through 11 show steps for several variations of the above-described process. In these variations, the grantor (“User1”) first registers 50 with the message board or forum (“B”). In other alternative embodiments, the grantor need not be registered with the bulletin board or forum. These variations shown presume that the poster being rewarded (“User2”) has already registered with the message board or forum (registration is often required by on-line boards and forums to have posting privileges), although it is possible for the poster to not be registered (in which case, the poster will need to provide sufficient information with their post to be able to direct grantors how to provide a tip or reward).

FIG. 7 shows a system using an “in-house” account associated with the message board or forum. The grantor needs to create an account 52 with the board or forum site. Initiating 60 the payment process (as described above) takes the grantor to a secure site within the board or forum site 54 where the grantor confirms the payment, causing funds to be transferred to the poster's (“User2”) account with the board or forum site 56. The poster may then be notified of the payment 100.

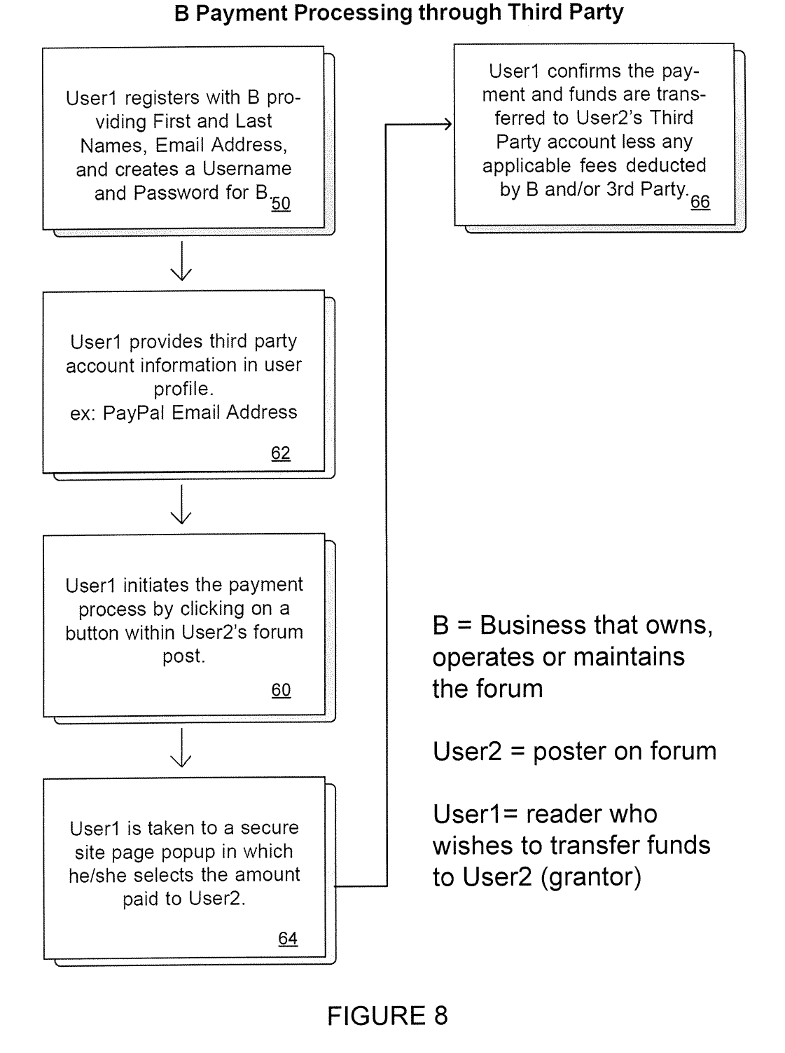

FIG. 8 shows a system where payments are processed through a third party. The grantor needs to provide the third party account information 62. Initiating 60 the payment process (as described above) takes the grantor to a secure site popup 64 where the grantor confirms the payment, causing funds to be transferred to the poster's (“User2”) account, which may be with any third party or with the board or forum site 66. The poster may then be notified of the payment 100.

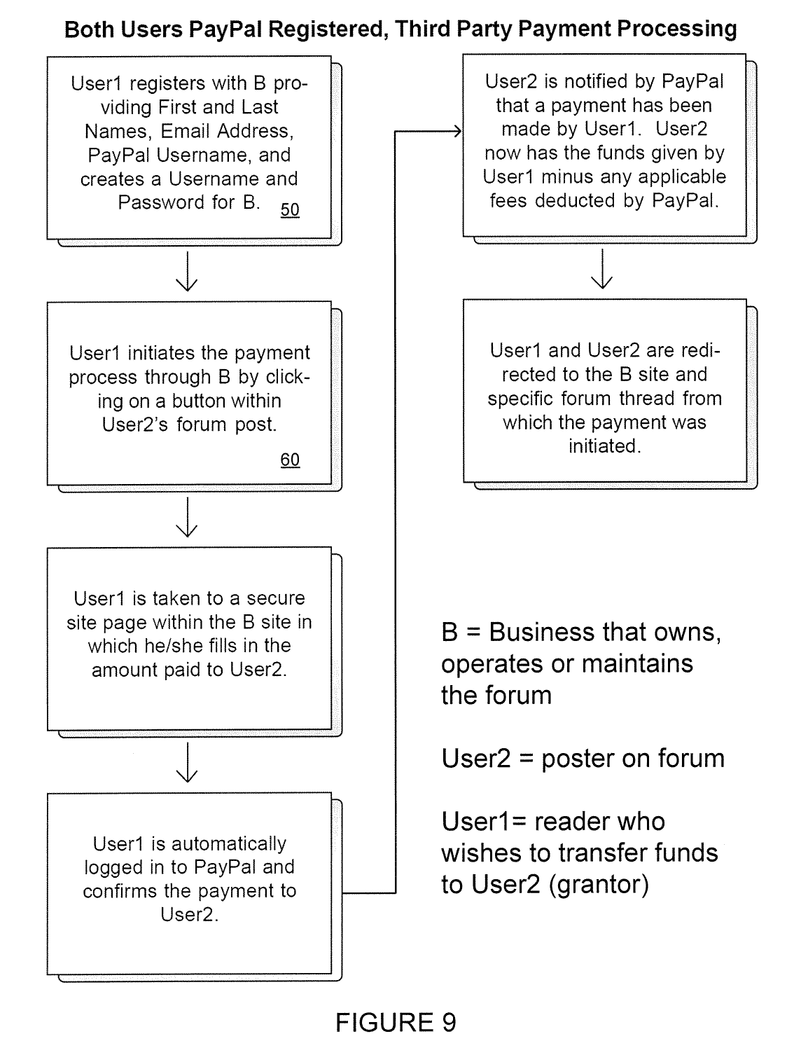

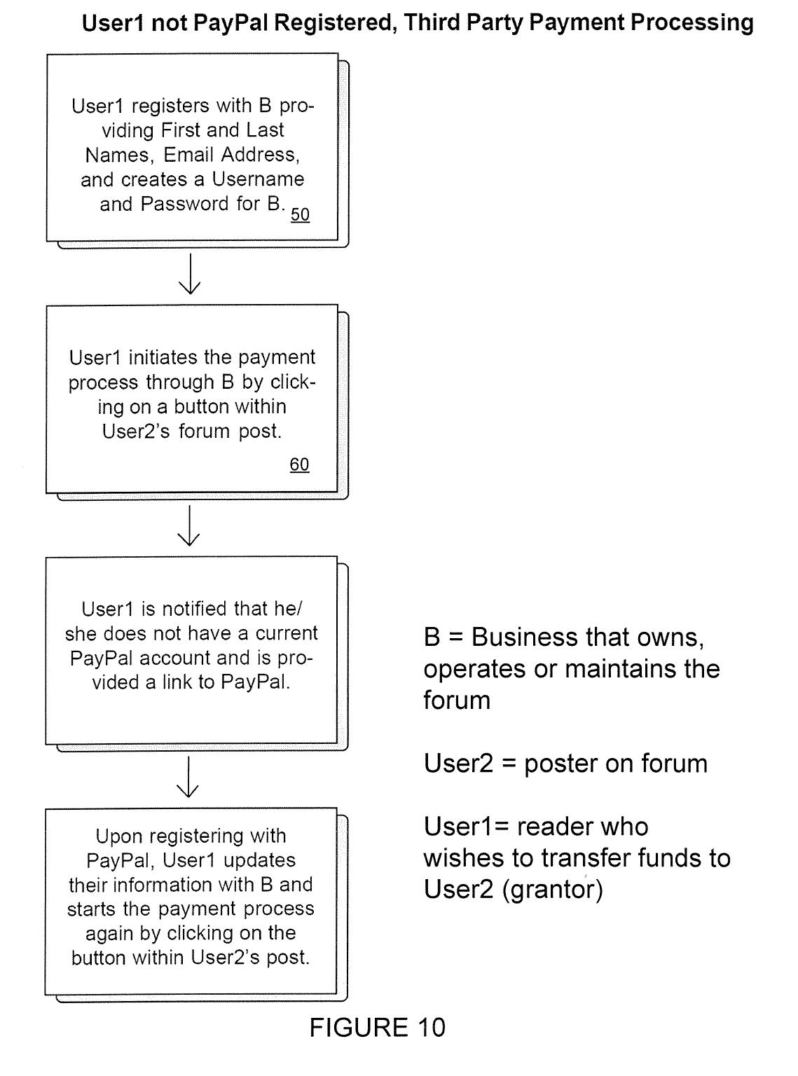

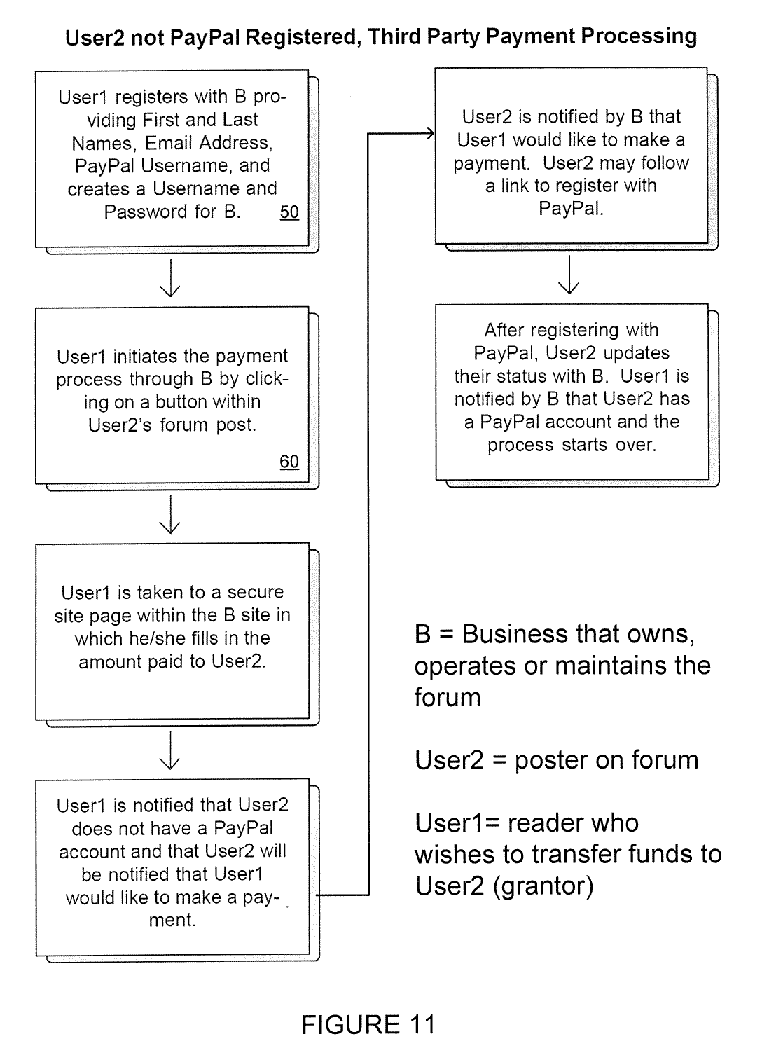

FIGS. 9 through 11 show possible systems using Paypal, as described above. In FIG. 9, both the grantor and the poster are registered with Paypal. In FIG. 10, the grantor is registered with Paypal, but the poster is not and is provided the option of registering with Paypal. In FIG. 11, the grantor is not registered with Paypal, and is prompted to register with Paypal to make the payment.

The owner, operator or person or entity affiliated with the message board containing the post being rewarded may receive a portion of the payment as a fee. The fee may be a fixed amount, a fixed amount based on the amount of the payment, a percentage of the amount of the payment, or a varying percentage of the amount of the payment, and may or may not be subject to a cap. Alternatively, a fee may be charged for registration. Said registration fee may be a single initial payment, a payment over time, or a recurring periodic payment, including but not limited to a subscription. The registration fee or subscription may be in addition to the fee based on payments to posters. Revenue also may be derived from advertising on the forum site.

In one exemplary embodiment, any post by a registered poster with valid account information would display the reward means as part of each post made by that poster. In an alternative embodiment, a poster may decline to provide account information, in which case any post by the poster would not display the reward means.

A forum using this system and method can be a single forum on a site, or one among multiple forums on a site. Multiple forums can be organized in a variety of ways, including by substantive subject matter.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. A system for providing payments to a poster on a message board or forum, comprising:
compensation means associated with a post by a poster, whereby activation of said compensation means initiates a payment process leading to the payment of compensation to the poster.

2. The system of claim 1, wherein the compensation means is a button or icon in or near the post.

3. The system of claim 2, wherein the button is colored.

4. The system of claim 3, wherein the button is green.

5. The system of claim 2, wherein the button is marked with a symbol or words, or combination thereof.

6. The system of claim 5, wherein the button is marked at least in part with the word “TIP”.

7. The system of claim 1, further comprising a payment screen activated by activating of the compensation means, said payment screen prompting the activator of the compensation means to designate a payment amount.

8. The system of claim 7, wherein the payment amount is transferred from one or more accounts of the activator to one or more accounts of the poster.

9. The system of claim 8, wherein one or more of the accounts of the activator are maintained with the site where the message board or forum are located.

10. The system of claim 8, wherein one or more of the accounts of the poster are maintained with the site where the message board or forum are located.

11. The system of claim 8, wherein one or more of the accounts of the activator are maintained with a third-party site separate from the site where the message board or forum are located.

12. The system of claim 8, wherein one or more of the accounts of the poster are maintained with a third-party site separate from the site where the message board or forum are located.

13. The system of claim 8, wherein one or more of the accounts of the poster and activator are Paypal accounts.

14. A method for providing payments to a poster on a message board or forum, comprising the steps of:
providing a message board or forum on which a poster posts a post; and
providing compensation means associated with said post, whereby activation of said compensation means initiates a payment process leading to the payment of compensation to the poster.

15. The method of claim 14, further comprising the step of:
displaying a payment screen in response to activation of the compensation means, said payment screen prompting the activator of the compensation means to designate a payment amount.

16. The method of claim 15, further comprising the step of:
transferring the payment amount from one or more accounts of the activator to one or more accounts of the poster.

17. The method of claim 15, further comprising the step of:
directing the activator of the compensation means to a third-party payment site.

18. The method of claim 14, wherein the compensation means is a button or icon in or near the post.
